(19) United States
(12) Patent Application Publication
(10) Pub. No.: US 2024/0329643 A1
(43) Pub. Date: Oct. 3, 2024

(54) PRECISION ARIAL DROP SYSTEM

(71) Applicant: Mark Kusbel, Peoria, AZ (US)

(72) Inventor: Mark Kusbel, Peoria, AZ (US)

(21) Appl. No.: 18/128,638

(22) Filed: Mar. 30, 2023

(51) Int. Cl. G05D 1/10; G05D 1/00

(52) U.S. Cl. CPC G05D 1/105

(57) ABSTRACT

Disclosed is an arial drop system for guiding a payload to a ground drop target in a predetermine drop area. The system includes a central processing unit (CPU), memory for storing a computer software instruction set for execution by the CPU, a high-resolution camera for taking and providing to the CPU real time images of the drop area and a second memory unit for pre-storing images of the drop area and the drop target. Under the control of the software instruction set, the CPU compares the real time images to the pre-stored images to guide the payload to the drop target.

### CROSS-REFERENCE TO RELATED APPLICATION

The present application claims priority to provisional patent application Ser. No. 63/325,478 filed on Mar. 30, 2022 and is entitled “Joint Precision Air Drop System”, said application being fully incorporated herein by reference.

### TECHNICAL FIELD

The present invention generally relates to the field of aerial guidance systems, and more particularly is directed to a vision-based precision air drop system.

### SUMMARY OF THE INVENTION

The air drop system of the present invention has a number of applications and improvements over the prior art where an aerial drop of a payload must be made with a great deal of precision as to landing target.

The system in accordance with the present invention is a self-steering vision guided airdrop system consisting of a parachute canopy and autonomous guidance unit. The system has particular application where drop accuracy and soft target impact from a high-altitude are importance objectives. Test of the system have shown its landing accuracy to be within 100 meters of the target location with a deployment offset from the target as great as 20 KM from an altitude of 24,500 ft mean sea level. The system can achieve an impact velocity of less than 28 ft/s.

### BRIEF DESCRIPTION OF THE DRAWINGS

The novel features of the present invention will be understood more fully and clearly from the following detailed description of the invention as set forth in the accompanying drawings in which:

FIG. 1 is an over-all illustration of one embodiment a vision based aerial guidance systems in accordance with the present invention; and

FIG. 2 is a block diagram of the control unit for the vision based aerial guidance system shown in FIG. 1.

### DESCRIPTION OF THE PREFERRED EMBODIMENT

A preferred embodiment of the present invention will be described with reference to the drawings.

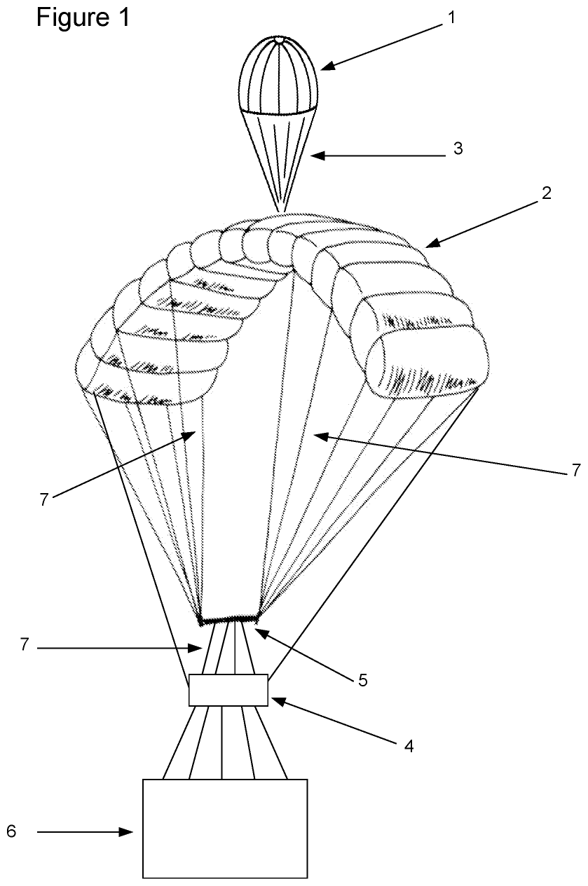

As shown in FIG. 1, the system includes a drogue parachute 1 which is attached to main parachute 2 by a plurality of Lines 3 as known in the art. The purpose of drogue parachute 1 is to lower the air speed of main parachute 2 and stabilize it prior to deployment. Parachute 2 is connected to Control Unit 4 through Slider 5 and then to Payload 6 via a plurality of suspension lines 7. As known in the art, Slider 5 is a rectangular piece of fabric with a grommet near each corner and is used to control the deployment of Parachute 2.

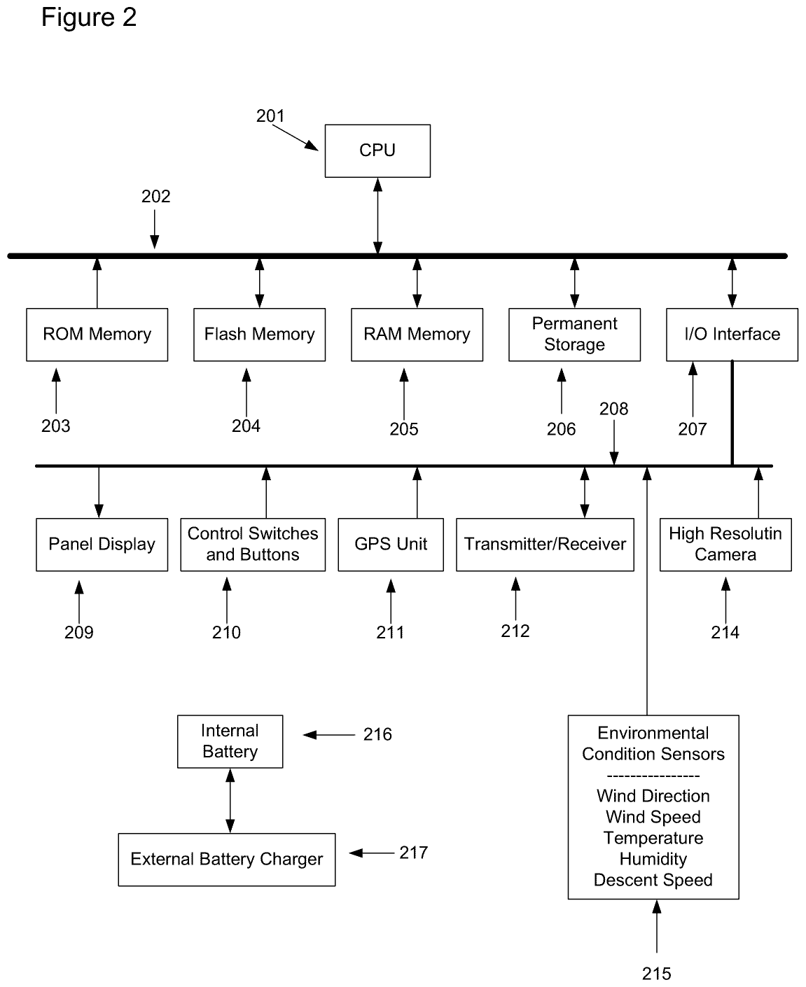

FIG. 2 is a block diagram of one embodiment of Control Unit 4.

As illustrated in FIG. 2, Control Unit 4 includes a CPU 201 which is used to execute computer software instructions as is known in the art. CPU 201 is coupled, via buss 202, to ROM Memory 203, Flash Memory 204, RAM Memory 205, Permanent Storage 206 and I/O Interface 207.

ROM Memory 203 and Flash Memory 204 may be used to store computer software instructions for execution by CPU 201. RAM memory 205 may also be used for storing computer software instructions, and especially for storing information that is only needed for a short period of time. Permanent Storage 206 is used for longer and larger data storage and its data may be transferred to a central data store for analysis after a drop mission. Such data may include continuously updated real time system performance information during the course of a drop mission.

RAM memory 205 and/or Permanent Storage 206 is also used to store pre-loaded satellite imagery of the designated area area and drop target.

The underlying firmware or software which CPU 201 executes may be updated from time to time in order to correct programming errors or to add additional features to the system.

As shown in FIG. 2, CPU 201 is also coupled to a number of peripheral interface devices via I/O Interface 207 and its own buss 208.

Panel Display 209 may be used to provide system and other information to system operators. Control Switches and Buttons 210 may be used by system operators to enter commands into the Control Unit 4.

GPS Unit 211 is used to receive GPS data.

Transmitter/Receiver 212 may be used for a system operator to communicate with the system.

High Resolution Camera 214 is used to take real time images of the drop area which can then be analogize for guidance purposes. Environmental Conditions Sensors 215 is used to measure a number of environmental conditions, including wind direction, wind speed, temperature, humidity and descent speed during a drop operation.

The system is powered by Internal Battery 216 which can be recharged by External Battery Charger 217.

High Resolution Camera 214 continuously takes images of the surrounding area and CPU 201 compares these images to the above mentioned pre-stored image data with the designated drop target. This information is then used by CUP 201 to guide Parachute 2 to the drop target. The system can also be supplemented with GPS data from GPS Unit 211 and from Environmental Condition Sensors 215.

While the foregoing specification and drawings teaches the principles of the present invention, with examples provided for the purpose of illustration, it will be appreciated by one skilled in the art from reading this disclosure that various changes in form and detail can be made without departing from the true scope of the invention.

I claim:

1. An arial drop system for guiding a payload to a ground drop target in a predetermine drop area, said system comprising:
a central processing unit (CPU);
a first memory unit coupled to said CPU for storing a computer software instruction set for execution by said CPU;
a camera coupled to said CPU for taking and providing to said CPU real time images of said drop area;
a second memory unit coupled to said CPU for pre-storing images of said drop area and said drop target; and
wherein said CPU executing said software instruction set compares said real time images to said pre-stored images to guide said payload to said drop target.
